(19) United States
(12) Patent Application Publication
(10) Pub. No.: US 2023/0040813 A1
(43) Pub. Date: Feb. 9, 2023

(54) APP MIGRATION SYSTEM AND INFORMATION STORAGE MEDIUM

(71) Applicant: Cybozu, Inc., Tokyo (JP)

(72) Inventors: Hirokuni MAETA, Kyoto-shi (JP); Yuta SAITO, Saitama-shi (JP); Naoki KAWAMUKAI, Nagareyama-shi (JP)

(21) Appl. No.: 17/666,573

(22) Filed: Feb. 8, 2022

(30) Foreign Application Priority Data
Aug. 6, 2021 (JP) 2021-129747

(51) Int. Cl. G06F 9/48; H04L 67/10; G06F 21/62

(52) U.S. Cl. CPC G06F 9/485; H04L 67/10; G06F 21/62; G06F 2209/482

(57) ABSTRACT

An app migration system including at least one processor which places an app in one of an inside and an outside of a space joined by at least one user in a user group in which information is shareable; sets, for the app, a permission corresponding to a placement location of the app; migrates the app in one of a route between a public space and a private space and a route between the inside and the outside of the space; and sets, for the migrated app, a permission corresponding to a migration destination of the app.

### CROSS-REFERENCE TO RELATED APPLICATION

The present disclosure contains subject matter related to that disclosed in Japanese Patent Application JP 2021-129747 filed in the Japan Patent Office on Aug. 6, 2021 the entire contents of which are hereby incorporated by reference.

### BACKGROUND OF THE INVENTION

### 1. Field of the Invention

The embodiments disclosed herein relate to an app migration system and a program.

### 2. Description of the Related Art

Hitherto, there has been known a system in which freely-selected information can be shared in a user group to which a plurality of users belong. For example, in Non-patent Literature 1 (https://jp.cybozu.help/k/ja/user/app_settings/rights/app_rights.html), there is described a technology for setting an access right to an app placed inside or outside a space joined by at least one user in the user group. For example, in Non-patent Literature 2 (https://support.airtable com/hc/en-us/articles/215589438-Moving-a-base-from-one-workspace-to-another-workspace), there is described a technology for setting an access right to a database created in a workspace in which a plurality of users can share information, and setting an access right corresponding to a workspace at a migration destination when the database is migrated to another workspace.

In such a system as described in Non-patent Literature 1, it is required to migrate an app between a public space and a private space or between inside and outside a space. When the app is successfully migrated therebetween, it is required to set an access right corresponding to the migration destination. It seems that time and labor of a user can be reduced when the access right corresponding to the migration destination can be automatically set. However, the concept of the workspace of Non-patent Literature 2 is different from that of the space of Non-patent Literature 1, and hence the technology of Non-patent Literature 2 cannot be applied to the technology of Non-patent Literature 1.

### SUMMARY OF THE INVENTION

One object of the present disclosure is to reduce time and labor of a user when an app is migrated.

According to at least one embodiment of the present disclosure, there is provided an app migration system including at least one processor configured to: place an app in one of an inside and an outside of a space joined by at least one user in a user group in which information is shareable; set, for the app, a permission corresponding to a placement location of the app; migrate the app in one of a route between a public space and a private space and a route between the inside and the outside of the space; and set, for the migrated app, a permission corresponding to a migration destination of the app.

### BRIEF DESCRIPTION OF THE DRAWINGS

FIG. 1 is a diagram for illustrating an example of an overall configuration of an app migration system.

FIG. 2 is a diagram for illustrating an example of a portal screen.

FIG. 3 is a diagram for illustrating an example of spaces created in a user group.

FIG. 4 is a diagram for illustrating an example of a space screen.

FIG. 5 is a diagram for illustrating an example of an app screen.

FIG. 6 is a diagram for illustrating an example of an app setting screen.

FIG. 7 is a diagram for illustrating an example of an access right setting screen.

FIG. 8 is a diagram for illustrating an example of the app setting screen on which a dialogue has been displayed.

FIG. 9 is a diagram for illustrating an example of settings of access rights before and after migration of the app.

FIG. 10 is a functional block diagram for illustrating functions implemented by the app migration system.

FIG. 11 is a table for showing a data storage example of a user group database.

FIG. 12 is a table for showing a data storage example of an app database.

FIG. 13 is a flow chart for illustrating an example of processing to be executed by the app migration system.

FIG. 14 is a flow chart for illustrating an example of the processing to be executed by the app migration system.

### DESCRIPTION OF THE EMBODIMENTS

### [1. Overall Configuration of App Migration System]

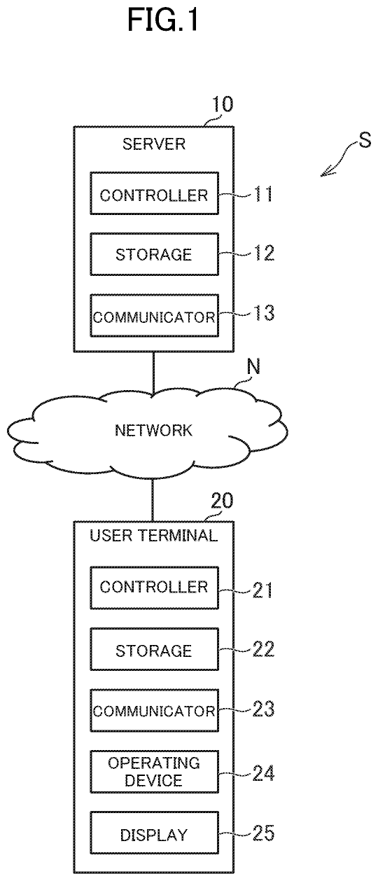

An example of an app migration system according to at least one embodiment of the present disclosure is described. FIG. 1 is a diagram for illustrating an example of an overall configuration of an app migration system. For example, an app migration system S includes a server 10 and a user terminal 20. A network N is, for example, the Internet or a LAN. The app migration system S is only required to include at least one computer, and is not limited to the example of FIG. 1.

The server 10 is a server computer. A controller 11 includes at least one processor. A storage 12 includes a volatile memory, for example, a RAM, and a non-volatile memory, for example, a hard disk drive. A communicator 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. Hardware configurations of a controller 21, a storage 22, and a communicator 23 may be the same as those of the controller 11, the storage 12, and the communicator 13, respectively. An operating device 24 is an input device, for example, a mouse, a keyboard, or a touch panel. A display 25 is a liquid crystal display or an organic EL display.

Programs or data described as being stored in the storages 12 and 22 may be supplied through the network N. Hardware configurations of the server 10 and the user terminal 20 are not limited to the above-mentioned examples, and various kinds of hardware can be employed. For example, a reader (for example, an optical disc drive or a memory card slot) for reading a computer-readable information storage medium or an input/output device (for example, a USB terminal) for directly connecting to an external device may be included. In this case, the program or data stored in the information storage medium may be supplied through intermediation of the reader or the input/output device.

### [2. Outline of App Migration System]

In the at least one embodiment, a case in which the app migration system S is applied to cloud-type groupware is taken as an example. A user can share freely-selected information with another user through use of groupware. For example, the user can share text, numerical values, tables, drawings, images, documents, videos, sounds, and other freely-selected files, or a combination thereof. For example, information can be shared in a user group.

The user group is a group of users who share information with one another. The user group is also a group of users who can log in to a predetermined webpage. For example, an organization, such as a company or a government office, corresponds to the user group. A department or a team in an organization also corresponds to the user group. Accordingly, there may be a plurality of user groups in one organization. At least one user belongs to a user group. A user belongs to at least one user group.

In the at least one embodiment, each user group is provided with a subdomain. There is a one-to-one correspondence between user groups and subdomains. A user group can be identified by a subdomain. For example, it is assumed that the domain of a groupware provider is “abcde.com.” When XYZ Company uses groupware, a subdomain, for example, “xyzcompany.abcde.com,” is assigned to XYZ Company. In this case, a group of employees of XYZ Company corresponds to the user group. The employees of XYZ Company access the above-mentioned subdomain to use the groupware.

For example, an administrator in a certain user group inputs information including the name and email address of a user to be invited to the certain user group. After the information is input, the user ID and password of the user are generated, and an invitation email is sent to the user. For example, the invitation email includes description of the user ID and password and a URL for logging in to the subdomain of the user group. When the user selects the URL included in the invitation email, a login screen for logging in to the subdomain of the user group is displayed on the display 25.

In the at least one embodiment, a case in which each of screens including the login screen is displayed through use of a browser is described, but each screen may be displayed through use of a groupware application. When the user inputs the user ID and the password on the login screen, the user logs in to the subdomain of the user group, and completes the process of joining the user group. When the user logs in to the subdomain of the user group, a portal screen is displayed on the display 25. The portal screen corresponds to a top page in the subdomain of the user group.

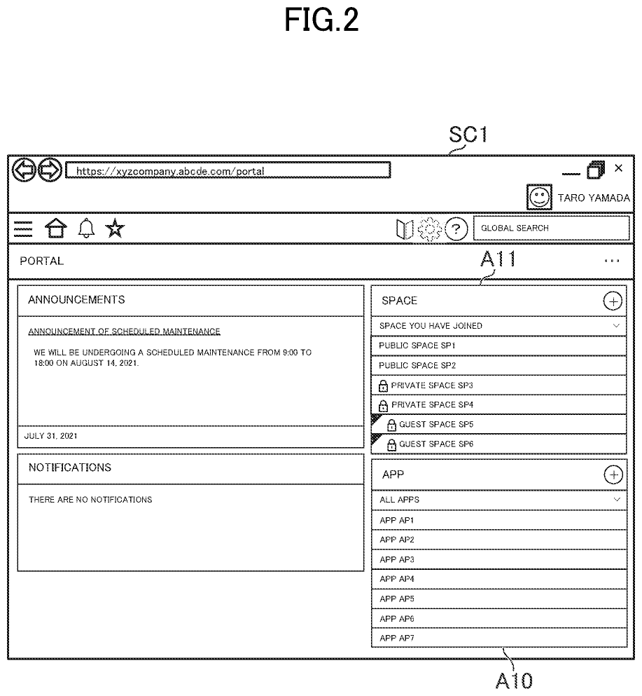

FIG. 2 is a diagram for illustrating an example of the portal screen. On a portal screen SC1, various images to be used by users to share information in the user group are displayed. For example, the portal screen SC1 includes a display area A10 for showing a list of apps available to the user and a display area A11 for showing a list of spaces joined by the user. In the at least one embodiment, among functions available in groupware, the function of information sharing using an app and the function of information sharing using a space are described.

The app is a tool for supporting the user's task. The app can also be considered as a task system tailored for the user's work. In the at least one embodiment, an app having the same function as that of spreadsheet software is taken as an example, but as the app itself, various known types of apps can be used. For example, an app having the same function as that of word-processing software, an app having the same function as that of image editing software, or an app having the same function as that of presentation software may be provided.

The user can use an app provided in advance by the groupware, or can create an app by himself or herself. The user can also use an app created by another user or another user group. For example, the app includes a program portion for executing some processing and an actual data portion to be viewed by the user. In the program portion, the user can specify a freely-selected calculation formula or code. It suffices that the data format of the app is a format compatible with the functions of the app.

The space is a place in which users communicate to/from each other. The space can also be said to be a function to be used for communication in units of teams. In the space, members can discuss and share information with each other. Any number of spaces can be created in one user group. Members of a space may be all or a part of the users in the user group. The user is not required to join the space. Even when the user does not join the space, the user can view the information in the user group as long as the user has been invited by the user group.

For example, when a certain company corresponds to the user group, the space is a department or team of the certain company. The space may be further divided in a certain department or team, or there may be a space that spans a plurality of departments or teams. In addition, there may be a space for communicating to/from people outside the company. In the space, freely-selected information is exchanged. The “information in the space” as described in the at least one embodiment means the information exchanged in the space.

In the at least one embodiment, a case in which only a user having a permission to create a space can create a space is described, but the concept of the permission to create a space is not particularly required. For example, the user having the permission to create a space designates members of the space. As the members, any users can be designated. A member can be added or removed after the space is created. In the at least one embodiment, a case in which there are three types of spaces, namely, a public space, a private space, and a guest space, is taken as an example.

The public space is a space that can be joined by all users. In the at least one embodiment, a case in which a member of the public space in a certain user group is designated from the certain user group is described, but the member may be designated from among the users in another user group. That is, the member of the public space in a certain user group may be a user who has not been invited to the certain user group. Information in the public space can be viewed not only by the members but also by people other than the members. The information in the public space of one user group may be viewable by users in another user group.

The private space is a space that can be joined by all users. A member of the private space in a certain user group can be designated from all users. In those respects, the private space is the same as the public space. However, the information in the private space can be viewed only by the members of the private space. The private space differs from the public space in this respect. Even a user invited to the user group cannot view the information in the private space that has not been joined by the user. When a user is added as the member of the private space, the user can view the information in the private space.

The guest space is a space that can be joined by users who do not belong to a user group. In this respect, the guest space differs from the public space and the private space. Even a user who has not been invited to any user group can be designated as the member of the guest space. The information in the guest space can only be viewed by the members of the guest space. Even a user invited to the user group cannot view the information in the guest space that has not been joined by the user. The flow of invitation to the guest space may be the same as the flow of invitation to the user group. An invitation email including the URL of a guest space is sent to a person invited to the guest space. The person invited to the guest space is hereinafter referred to as “guest user.” The guest user creates a user ID for the guest to join the guest space. The guest user can only view the information in the guest space joined by the guest user. The guest user cannot view the information in the public space, the private space, and the guest space to which the guest user has not been invited. The guest user cannot also view the information in the guest space to which the guest user has been invited but which has not yet been joined by the guest user.

The public space, the private space, and the guest space are hereinafter referred to simply as “spaces” when there is no particular distinction thereamong. The above-mentioned app can be placed in a space. The placing of an app in a space means associating the space with the app. The app placed in a space is hereinafter referred to as “in-space app. ” The actual data portion of the in-space app in a certain space corresponds to the information exchanged in this space.

In the at least one embodiment, it is also possible to share information outside the space. For this reason, some apps are placed outside the space. The app placed outside the space is hereinafter referred to as “out-space app. ” The in-space app and the out-space app are hereinafter referred to simply as “apps” when there is no particular distinction therebetween. The out-space app is an app that is not associated with any space. When an out-space app for a certain user group is updated, a notification of the update is sent to all or a part of the users in the certain user group.

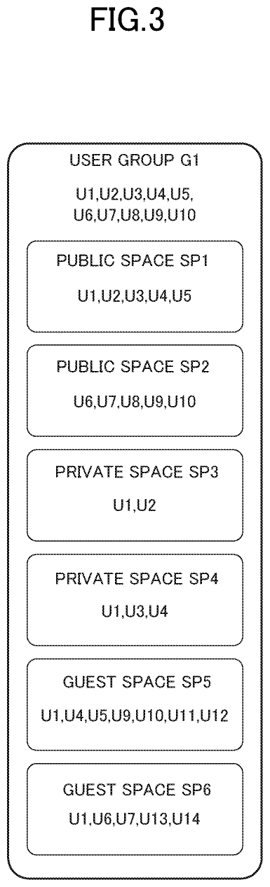

FIG. 3 is a diagram for illustrating an example of spaces created in the user group. For example, a user group G1 is a company for which 10 users U1 to U10 work. In the example of FIG. 3, public spaces SP1 and SP2, private spaces SP3 and SP4, and guest spaces SP5 and SP6 are created in the user group G1. The users U1 to U10 can also communicate to/from one another outside those spaces.

For example, the public space SP1 has been joined by the users U1 to U5. The users U6 to U10 and other users who have not joined the public space SP1 can also view the information in the public space SP1. The public space SP2 has been joined by the users U6 to U10. The users U1 to U5 and other users who have not joined the public space SP2 can also view the information in the public space SP2.

The private space SP3 has been joined by the users U1 and U2. The users U3 to U10 and other users who have not joined the private space SP3 cannot view the information in the private space SP3. The private space SP4 has been joined by the users U1, U3, and U4. The users U2 and U5 to U10 and other users who have not joined the private space SP4 cannot view the information in the private space SP4.

The guest space SP5 has been joined by the users U1, U4, U5, U9, and U10 and guest users U11 and U12. The users U2, U3, and U6 to U8 and other users who have not joined the guest space SP5 cannot view the information in the guest space SP5. The guest space SP6 has been joined by the users U1, U6, and U7 and guest users U13 and U14. The users U2 to U5 and U8 to U10 and other users who have not joined the guest space SP6 cannot view the information in the guest space SP6.

In addition to the example of FIG. 3, there are various user groups and spaces in the app migration system S. The portal screen SC1 of FIG. 2 is a screen corresponding to the user U1 in the user group G1 of FIG. 3. Lists of apps and spaces that can be accessed by the user may be displayed in the display areas A10 and A11 of the portal screen SC1. The private space that cannot be accessed by the user may be inhibited from being displayed in the display area A11. The user can select any space from the display area A11. For example, when the user selects the public space SP1 from the display area A11, a space screen for viewing the information in the public space SP1 is displayed on the display 25.

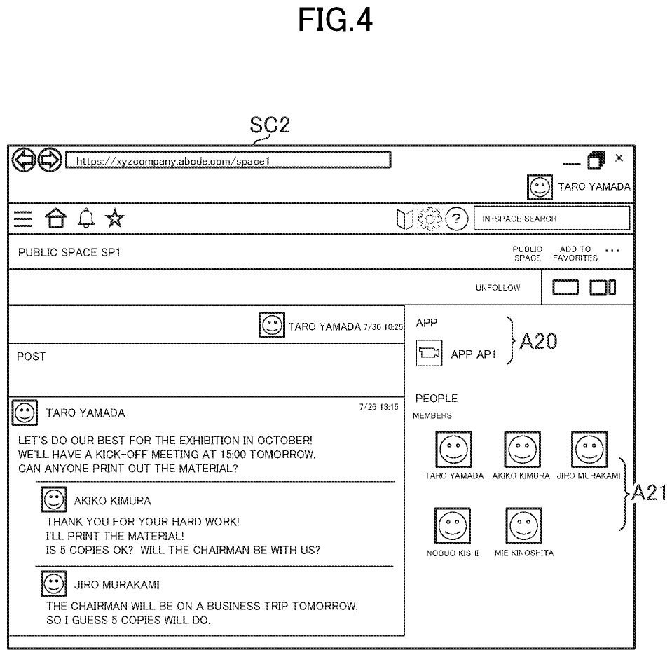

FIG. 4 is a diagram for illustrating an example of the space screen. A space screen SC2 includes a display area A20 for showing a list of in-space apps and a display area A21 for showing a list of members of the space and users followed by the user. Information exchanged in threads created in the public space SP1 or various kinds of other information can also be displayed on the space screen SC2. The user can select any in-space app from the display area A20. When the user selects an in-space app from the display area A20, an app screen for viewing the actual data portion of the selected in-space app is displayed on the display 25.

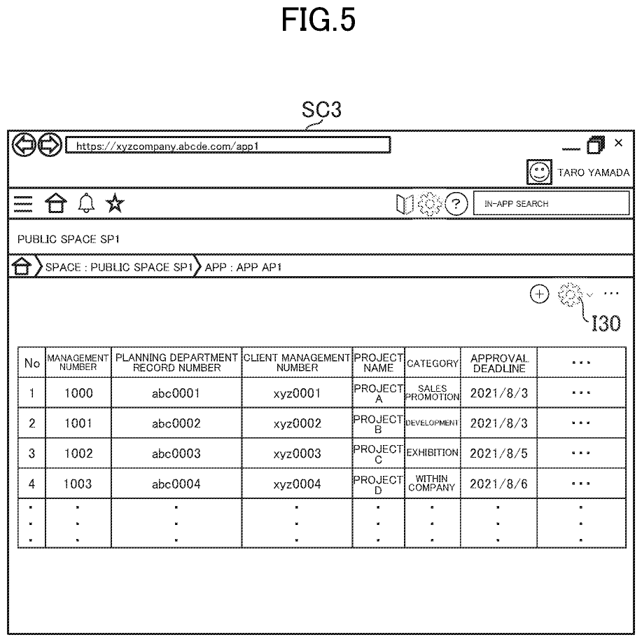

FIG. 5 is a diagram for illustrating an example of the app screen. In the example of FIG. 5, the actual data portion of an in-space app is displayed on an app screen SC3 in a table format. In the at least one embodiment, an access right is set for the in-space app. The user can perform an operation corresponding to his or her own access right. An access right is set for the out-space app as well. In the case of such a table format as shown in FIG. 5, an access right may be set in units of records or fields.

The access right to the app is one of the settings of the app. Known settings can be performed as the app settings themselves, and various settings other than the access right can be performed. The user can specify the settings of the app on the app screen SC3. For example, when an icon 130 on the app screen SC3 is selected, an app setting screen for performing the settings of the app displayed on the app screen SC3 is displayed on the display 25.

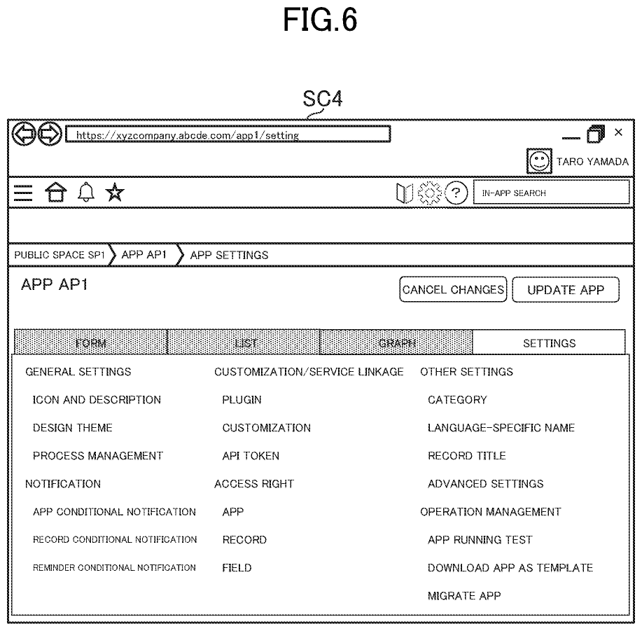

FIG. 6 is a diagram for illustrating an example of the app setting screen. As understood from an app setting screen SC4, various settings can be performed for the app. In this case, among the settings of the app, the access right to the app is described. For example, when the user selects “APP” under “ACCESS RIGHT” on the app setting screen SC4, an access right setting screen for setting the access right to the selected app is displayed on the display 25.

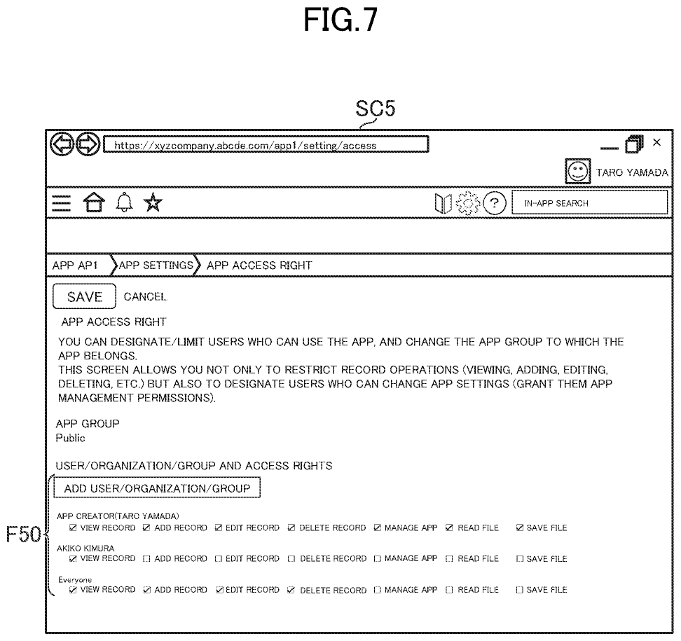

FIG. 7 is a diagram for illustrating an example of the access right setting screen. On an access right setting screen SC5, it is possible to designate or limit the users who can use the selected app, and to change an app group to which the app belongs, which is described later. In the at least one embodiment, a case in which an access right corresponding to a placement location of the app and an app-specific access right are provided as the access rights to the app is taken as an example.

The access right corresponding to the placement location of the app is an access right common to the placement location of the app. For example, in the case of the private space, only the members can access the app, and hence accessibility assigned to only the members of the private space corresponds to an access right corresponding to the placement location being the private space. In the case of the public space or a location outside the space, anyone can access the app, and hence accessibility assigned to anyone corresponds to an access right corresponding to the placement location being the public space or the location outside the space. In the at least one embodiment, the app group illustrated in FIG. 7 also corresponds to one of the access rights corresponding to the placement location of the app.

The app group is a group for collectively managing the access rights to a plurality of apps. The access rights to the app can be collectively set for the plurality of apps through use of the app group. The use of the app group enables not only the access right but also a permission, for example, a permission to create the app or a permission to manage the app, to be collectively managed. The settings of the access rights are the same for the apps belonging to a certain app group.

An app belongs to any one app group. In the at least one embodiment, when an app is created, the app belongs to an app group called “Public” by default. For example, an app belonging to the app group of “Public” can be disclosed to users other than the creator of the app (that is, all users). It is also possible to create any app group other than “Public.” In the at least one embodiment, it is assumed that a special permission is required for creating an app group. It is also possible to change the default app group from “Public” to another app group.

In the at least one embodiment, it is assumed that the in-space app belongs to “Public,” and the app group cannot be changed. However, even under the same app group of “Public,” an in-space app in the public space and an in-space app in the private space are different from each other in the user who can access the in-space app. The public space can be viewed by all users, and hence the “Public” of the in-space app in the public space means that all users can access the in-space app. The private space can be viewed only by the members, and hence the “Public” of the in-space app in the private space means that only the members can access the in-space app. Even with the app group of “Public,” the in-space app in the private space is not always accessible to all users.

For the out-space app, the app group can be changed from “Public” to another app group. As another app group, there may be a “Private” app group that can be accessed only by the creator of the app or an original app group created by a user who has the permission to create the app group. In the original app group, operations including creation, management, use, and deletion of an app belonging to the original app group can be permitted or prohibited for a user, a user group, and a group in the user group. In the example of FIG. 7, the in-space app is illustrated, and hence the app group cannot be changed. However, for the out-space app, the app group can be changed on the access right setting screen SC5.

The app-specific access right is an access right specified for each individual app. The access right to one app and the access right to another app are different from each other. Accordingly, even apps belonging to the same app group have app-specific access rights independent of each other. In the example of FIG. 7, the app-specific access rights can be set from an input form F50. For example, the access rights can be set for each user, organization, or group. The access rights can include any item, for example, “VIEW RECORD,” “ADD RECORD,” “EDIT RECORD,” “DELETE RECORD,” “MANAGE APP,” “READ FILE,” and “SAVE FILE.”

In the at least one embodiment, the placement location of the app can also be changed from the app setting screen SC4 of FIG. 6. For example, when “MIGRATE APP” is selected on the app setting screen SC4, a dialog for migrating an app is displayed.

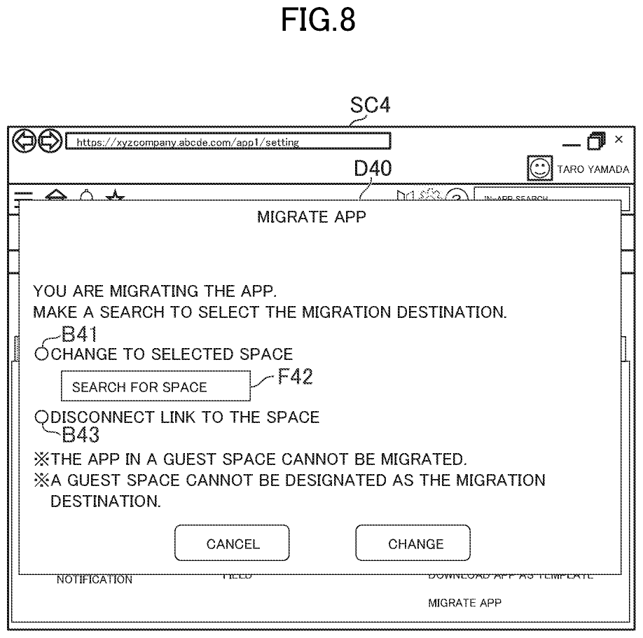

FIG. 8 is a diagram for illustrating an example of the app setting screen SC4 on which the dialogue has been displayed. As illustrated in FIG. 8, in a dialogue D40, there are displayed a button B41 for designating a space of a migration destination of the app, an input form F42 for searching for the space of the migration destination of the app, and a button B43 for migrating the app to the outside of the space. When the user is to migrate the in-space app in a certain space to another space, the user selects the button B41 and then retrieves and designates the space of the migration destination from the input form F42.

The user selects the button B43 to migrate the in-space app to the outside of the space. FIG. 8 is an illustration of a case in which the selected app is an in-space app, but the button B43 may be inhibited from being displayed when an out-space app is selected. In the at least one embodiment, the migration of the in-space app in the guest space is prohibited. It is also prohibited to designate the guest space as the migration destination. When the user selects the migration destination of the app from the dialogue D40, the app can be migrated after precautions are displayed. When the app is migrated, the access rights corresponding to the migration destination are set.

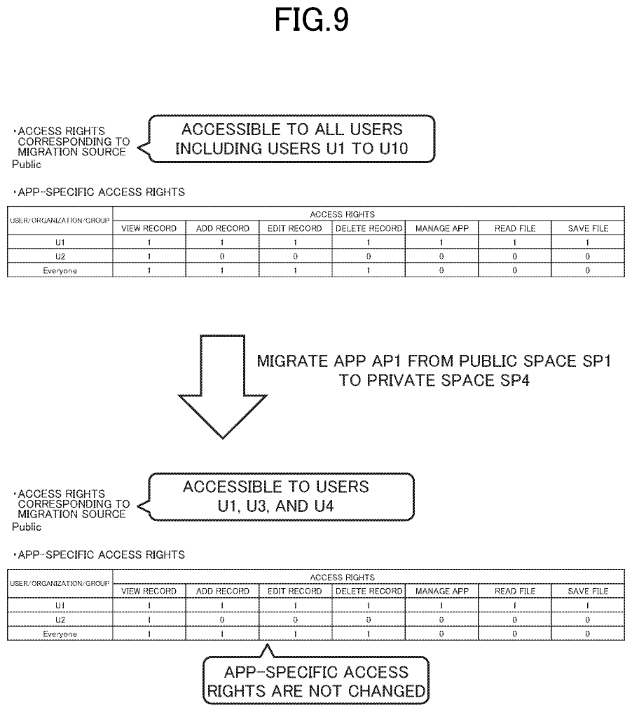

FIG. 9 is a diagram for illustrating an example of the settings of access rights before and after the migration of the app. In the example of FIG. 9, a case in which the app in the public space SP1 has been migrated to the private space SP4 is illustrated. As illustrated in FIG. 9, the app group remains “Public” without a change before and after the migration. However, “Public” in the public space SP1 of the migration source means that all users can access the app, but “Public” in the private space SP4 of the migration destination means that only the users U1, U3, and U4 being the members can access the app. Meanwhile, the app-specific access right does not change before and after the migration. When the access to the app is to be actually controlled, the control is performed based on a logical product of the access right determined by the app group and the app-specific access right.

In the example of FIG. 9, only the users U1, U3, and U4 are set to be able to access the app as the access right corresponding to the private space SP4 of the migration destination. As the app-specific access right, the settings for the users U1 and U2 and the settings for “Everyone” common to all users are defined. The settings for the user U1 are provided to both, and hence the settings for the user U1 specific to the app are applied to the user U1. The settings for “Everyone” are applied to the users U3 and U4. The app-specific access right is set for the user U2, but the user U2 is not a member of the private space SP4, and thus cannot access the app. In the same manner, other users correspond to “Everyone” but are not members of the private space SP4, and thus cannot access the app.

As described above, in the app migration system S according to the at least one embodiment, the access right corresponding to the placement location and the app-specific access rights are set for each individual app. An app placed outside the guest space can be migrated to any location other than the guest space. When the app is migrated, the access right corresponding to the migration destination is set, but the app-specific access rights are not changed. Such a configuration is employed to reduce time and labor of the user when the app is migrated. Now, details of the app migration system S are described.

[3. Functions implemented by App Migration System]

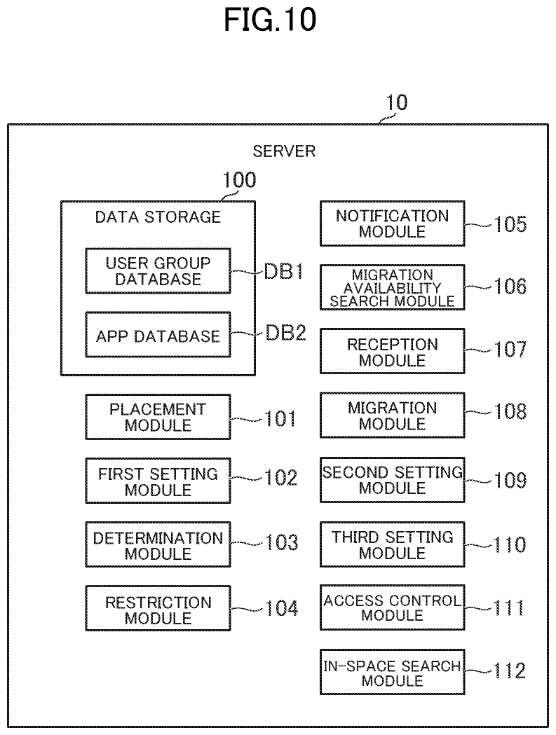

FIG. 10 is a functional block diagram for illustrating functions implemented by the app migration system S. In the at least one embodiment, a case in which the main functions are implemented by the server 10 is described. A data storage 100 is implemented mainly by the storage 12. Each of the other functions is implemented mainly by the controller 11.

### [Data Storage]

The data storage 100 is implemented mainly by the storage 12. The data storage 100 stores data required for the functions provided by the groupware. In the at least one embodiment, a user group database DB1 and an app database DB2 are described as examples of the above-mentioned data.

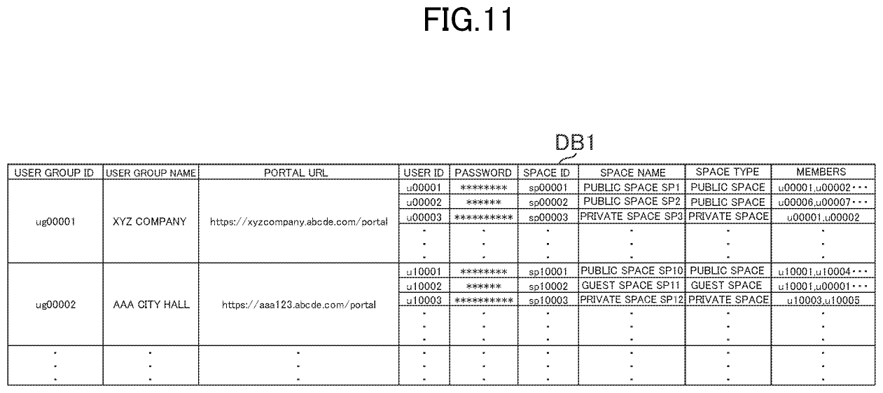

FIG. 11 is a table for showing a data storage example of the user group database DB1. The user group database DB1 is a database in which information relating to a user group is stored. For example, the user group database DB1 stores a user group ID, a user group name, a portal URL, a user ID, a password, a space ID, a space name, a space type, and a member. When a new user group is created, a new record corresponding to the new user group is created, and the information including the user group ID of the new user group is stored.

The user group ID is an ID that can identify the user group. The user group ID of a certain user group is associated with a user ID that can identify a user belonging to the certain user group. The user group ID of the certain user group is associated with a space ID that can identify a space created in the certain user group. The space type is information that can identify a type of the space. In the at least one embodiment, the space type indicates any one of the three types of spaces, namely, a public space, a private space, and a guest space. The space ID of a certain space is associated with the user ID of a member of the certain space. The guest space may be isolated from the user group in terms of data.

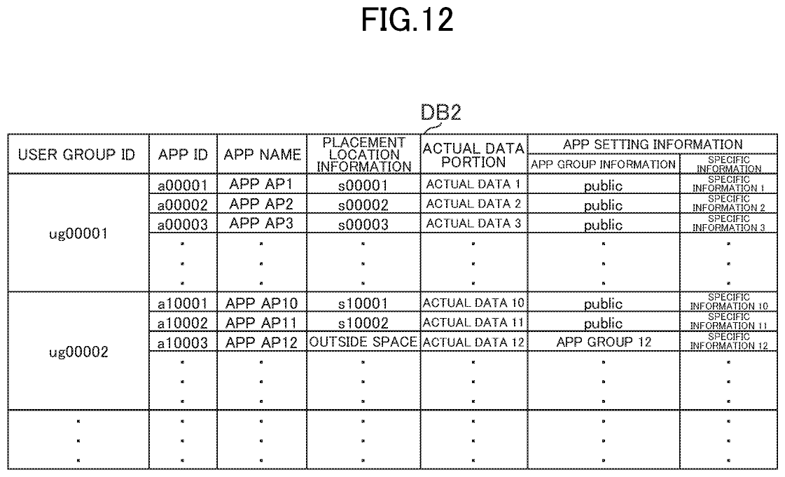

FIG. 12 is a table for showing a data storage example of the app database DB2. The app database DB2 is a database in which information relating to an app is stored. For example, the app database DB2 stores a user group ID, an app ID, an app name, placement location information, an actual data portion of the app, and app setting information. When a new app is created, a new record corresponding to the new app is created, and the information including the user group ID of the user group in which the new app is created and the app ID is stored.

The placement location information is information that can identify the placement location of the app. In the case of an in-space app, the space ID is stored as the placement location information. In the case of an out-space app, the placement location information indicating that the app is placed outside the space is stored. The placement location information is not required to be stored for an out-space app. In this case, the fact that the placement location information is not stored means that the app is an out-space app.

The app setting information is information indicating details of the settings of the app. In the at least one embodiment, the app setting information includes app group information that can identify the app group and specific information that can identify the access right specific to the app. In the at least one embodiment, the app setting information on an in-space app includes the app group information indicating that the app group is “Public” and the specific information set for the in-space app. The app setting information on an out-space app includes app group information indicating the app group of “Public” or another app group and specific information set for the out-space app. The specific information indicates the app-specific access rights described with reference to FIG. 7.

The data stored in the data storage 100 is not limited to the above-mentioned examples. It suffices that the data storage 100 stores the data required for the functions provided by the groupware. For example, the data storage 100 may store a user database in which information relating to individual users is stored. The data storage 100 may store a database in which actual data of information shared in each individual user group or space is stored. In addition, for example, the data storage 100 may store details of the settings of the permission defined for each individual app group.

### [Placement Module]

A placement module 101 places an app inside or outside a space joined by at least one user in a user group capable of sharing information. For example, setting the space ID of a certain space as the placement location information associated with the app ID of a certain app in the app database DB2 corresponds to placing the certain app in the certain space. Meanwhile, setting the information indicating the location outside the space as the placement location information associated with the app ID of a certain app in the app database DB2 corresponds to placing the certain app outside the space.

For example, when an app is created on the space screen SC2 of a certain space, the placement module 101 places the created app as an in-space app in the certain space. When an app is created on the portal screen SC1, the placement module 101 places the created app as an out-space app outside the space. When the placement location is designated at a time of creation of the app, the placement module 101 may place the created app at the designated placement location.

### [First Setting Module]

A first setting module 102 sets, for an app, a permission corresponding to the placement location of the app. The permission to be set may be any permission relating to the app, and is not limited to the access right. For example, the permission to be set may be an app management permission, a migration permission, a deletion permission, a setting change permission, or a combination thereof. It is assumed that a relationship between a placement location and the permission corresponding to the placement location is defined in the data storage 100. The first setting module 102 sets the permission for the app so that the permission associated with the placement location of the app is set.

For example, in a case of an in-space app placed in a certain private space, the first setting module 102 sets an access right to the in-space app so that only the members of the private space have the access right. In a case of an in-space app placed in a certain guest space, the first setting module 102 sets the access right to the in-space app so that only the members of the certain guest space have the access right.

For example, in a case of an in-space app placed in a certain public space, the first setting module 102 sets an access right to the in-space app so that all users have the access right. In the case of an out-space app placed outside the space, the first setting module 102 sets an access right to the out-space app so that the user has the access right defined for the app group to which the out-space app belongs.

In the at least one embodiment, the first setting module 102 sets, for an app, a permission specific to the app. Even when the app is migrated by the migration module 108 described later, the settings of the permission specific to the app are maintained. That is, the permission specific to the app is not changed even when the app is migrated. The permission specific to the app is changed by the user's operation.

### [Determination Module]

A determination module 103 determines whether or not a user instructing the migration of an app has the app management permission and the user has an app creation permission at the migration destination of the app. The user instructing the migration of the app is a user who has displayed the app setting screen SC4. The app management permission indicates that actions including changing and deleting the settings of an app are permitted. The app creation permission indicates that the creation of an app is permitted inside or outside the space. Users, organizations, and the like having the app management permission and the app creation permission are defined in the app group. For example, in the case of an in-space app, the determination module 103 determines based on the management permission and the creation permission associated with the app group of “Public” whether or not the user instructing the migration of the app has those permissions.

For example, when a migration source of the app is in a space, the determination module 103 may further determine whether or not the user instructing the migration of the app has the permission to manage the space. The permission to manage the space indicates that actions including changing and deleting the settings of the space are permitted. Users, organizations, and the like having the space management permission are defined in, for example, the user group database DB1. For example, the determination module 103 refers to the app database DB2 to identify the current placement location of the app to be set on the app setting screen SC4. When the identified placement location is in a space, the determination module 103 refers to the user group database DB1 to determine whether or not the user instructing the migration of the app has the permission to manage the space.

### [Restriction Module]

A restriction module 104 restricts the migration of an app based on a predetermined condition. It suffices that the condition is a condition for determining whether or not to permit the migration of the app, and a freely-selected condition can be set. For example, the restriction module 104 restricts the migration of the app relating to a space which is set so that information to be shared therein is isolated. The isolation of information means that a range for disclosing information is different from another location. In the at least one embodiment, the guest space corresponds to an example of such a space. The information in the guest space can be viewed only by a member of the guest space even when the user has been invited to the user group, and is thus isolated from the information in the public space or the private space.

For example, the space in the at least one embodiment includes a guest space that can be joined by a guest user who does not belong to the user group. The restriction module 104 restricts the migration of an app between the guest space and another space. The migration of an app between the guest space and another space is at least one of the migration of an app from the guest space to another space or the migration of an app from another space to the guest space.

For example, when the current placement location of a certain in-space app is a guest space, the restriction module 104 restricts the migration of the certain in-space app. The restriction module 104 restricts the migration of an app so that the app is not to be migrated from the guest space. An app migration restricting method itself can be any method, and examples thereof may include, in regard to the in-space app in the guest space: inhibiting the item of “MIGRATE APP” on the app setting screen SC4 from being selected; allowing the above-mentioned item to be selected but inhibiting the dialogue D40 from being displayed; allowing the dialogue D40 to be displayed but inhibiting a button for instructing the migration from being selected; and allowing the above-mentioned button to be selected but returning an error after that.

As the condition for the migration of an app, any condition can be set in addition to the condition relating to the guest space. For example, the app itself may be set as to whether or not a function of changing the space to which the app belongs is enabled. In this case, the following condition is set as a condition: that a space function of the app is turned on and that the function is turned on as an opt-in setting. In addition, for example, such a management permission or the like as to be determined by the determination module 103 is also set as one of the conditions. The following condition may also be set as a condition: that the permission to create the app in the app group of “Public” is provided, that the permission to create the app with the access right in system administration is provided, that the user is a member of a private space when the space of the migration destination is the private space, or that the migration destination is not the same as the current location.

### [Notification Module]

When the migration of an app is restricted, a notification module 105 notifies the user of a reason for the restriction. In the at least one embodiment, the migration module 108 migrates an app when a predetermined condition is satisfied. Accordingly, when the predetermined condition is not satisfied, the notification module 105 notifies the user instructing the migration of the app of a reason that the predetermined condition is not satisfied. The reason corresponds to details of the unsatisfied condition. A method of notifying the reason may be any method, and examples thereof may include: displaying a balloon indicating the reason when a mouse pointer points to the item of “MIGRATE APP” on the app setting screen SC4; displaying a message indicating the reason at a time at which the app setting screen SC4 is displayed; displaying the message indicating the reason in the dialogue D40; and displaying the message indicating the reason on an error screen after the dialogue D40. The notification of the reason is not limited to a visual notification, but may be an auditory notification using a voice. The item of “MIGRATE APP” may be displayed only when the function of migrating the app is turned on.

### [Migration Availability Search Module]

A migration availability search module 106 searches for a space to which the app can be migrated based on a predetermined condition. For example, the migration availability search module 106 searches for a space to which the app designated as a migration subject can be migrated, and displays search results thereof in the dialogue D40. In the at least one embodiment, the app can be migrated to any space other than the guest space, and hence the migration availability search module 106 searches the spaces in the user group to which the user belongs for a space other than the current placement location of the app as the space to which the app can be migrated. For example, when the user inputs some character string in the input form F42, the migration availability search module 106 searches for a space including the input character string in its space name. A space that does not satisfy the condition described in the processing of the restriction module 104 is not hit in the search results.

### [Reception Module]

A reception module 107 receives designation of the migration destination by the user instructing the migration of the app. In the at least one embodiment, the search by the migration availability search module 106 is executed, and hence the reception module 107 receives the designation of the migration destination by the user instructing the migration of the app from among the search results obtained by the migration availability search module 106. For example, the search results are displayed in a pull-down menu of the input form F42. The user can designate any space from the pull-down menu. The reception module 107 receives the designation of any one of the search results displayed in the pull-down menu. Various known methods can be employed as a search result display method itself, and the search result display method is not limited to the pull-down menu.

### [Migration Module]

The migration module 108 migrates an app between a public space and a private space or between inside and outside a space. The migration of the app means changing the placement location of the app. The migration module 108 migrates the app by updating the placement location information stored in the app database DB2. The migration module 108 changes the placement location of the app designated as the migration subject from the current placement location to the migration destination. In the at least one embodiment, the migration destination is designated from among the search results of the migration availability search module 106, and hence the migration module 108 migrates the app to the migration destination designated by the user.

The migration of an app between the public space and the private space is at least one of the migration of an app from the public space to the private space or the migration of an app from the private space to the public space. The migration of an app between inside and outside the space is at least one of the migration of an app from inside the space to outside the space or the migration of an app from outside the space to inside the space.

For example, when an out-space app has an app group other than “Public,” the migration module 108 may migrate the app into a space on condition that the app group of the app is changed to “Public.” When the out-space app belongs to an app group other than “Public,” the migration module 108 avoids migrating the out-space app. The migration module 108 migrates the out-space app to a space on condition that the out-space app is set to belong to the app group of “Public.” It is assumed that the app group is manually changed by the user before the migration of the out-space app, but the app group may be automatically changed after some dialogue or the like for confirmation is displayed.

In the at least one embodiment, the migration module 108 migrates an app based on a determination result obtained by the determination module 103. The migration module 108 avoids migrating the app when it is not determined that a user instructing the migration of the app has the app management permission and the user has the app creation permission at the migration destination of the app. The migration module 108 migrates the app when it is determined that a user instructing the migration of the app has the app management permission and the user has the app creation permission at the migration destination of the app.

In the at least one embodiment, when the migration source of an app is in a space, it is further determined whether or not the user instructing the migration of the app has the permission to manage the space, and hence there are at least three conditions for the migration of the app. The migration module 108 avoids migrating the app when at least one of those three conditions is not satisfied. The migration module 108 migrates the app when all of those three conditions are satisfied. When there is another condition as described above, the migration module 108 migrates the app in principle when all the conditions are satisfied. The migration module 108 avoids migrating the app in principle when a part of the conditions is not satisfied.

The migration module 108 can also migrate an app between a plurality of private spaces. The migration of an app between a plurality of private spaces is the migration of an app from one private space to another private space. The migration module 108 can also migrate an app between a plurality of public spaces.

### [Second Setting Module]

A second setting module 109 sets, for an app migrated by the migration module 108, a permission corresponding to the migration destination of the app. The meaning of the permission is as described in regard to the first setting module 102. For example, when the migration destination is a private space, the second setting module 109 sets an access right to the in-space app migrated to the private space so that only the members of the private space have the access right. When the migration destination is a public space, the second setting module 109 sets an access right to the in-space app migrated to the public space so that all users have the access right. When the migration destination is outside the space, the second setting module 109 sets an access right to the out-space app so that the user has the access right defined for the app group to which the out-space app belongs. When an app is migrated between a plurality of private spaces, the second setting module 109 sets an access right so that the members of the private space being the migration destination can access the app.

### [Third Setting Module]

A third setting module 110 can set a permission common to a plurality of apps. In the at least one embodiment, the permission to be set is a permission defined by the app group. The common permission may be a permission called by a name other than the app group. For example, the third setting module 110 sets, for an in-space app, the app group of “Public” indicating that the in-space app can be disclosed to all users. In the at least one embodiment, only the app group of “Public” can be set for the in-space app, and hence the third setting module 110 sets “Public” for the in-space app. An out-space app is also set to the app group of “Public” as a default setting.

For example, the third setting module 110 sets the app group of “Public” or another app group for the out-space app. The out-space app can be set to belong to any app group including “Public,” and hence the third setting module 110 sets the out-space app so that the out-space app is set to belong to the app group designated by the user having the app management permission. It is assumed that detailed settings of each individual app group are stored in the data storage 100. For example, as the detailed settings of the app group, access rights may be specified for each user or organization.

### [Access Control Module]

An access control module 111 controls the access to the app based on the permission set for the app. In the at least one embodiment, the access control module 111 controls the access to the app migrated by the migration module 108 based on a logical product (AND condition) of the permission for the app corresponding to the migration destination and the permission specific to the app. The access control module 111 permits a certain user's access to the app when the certain user has the permission corresponding to the migration destination of the app and has the permission specific to the app. The access control module 111 avoids permitting a certain user's access to the app when the certain user does not have at least one of the permission corresponding to the migration destination of the app or the permission specific to the app.

For example, the access control module 111 controls the access to the app for which the permission has been set by the third setting module 110 based on the logical product of the permission set by the third setting module 110 and another permission. It suffices that the another permission is a permission other than the permission set by the third setting module 110, and is a permission set by the first setting module 102 or the second setting module 109. When there is a function for setting a permission other than the first setting module 102 and the second setting module 109, a permission set by the function may correspond to the another permission. For example, the access control module 111 permits the app to be accessed by the user permitted to access the app based on both the permission set by the third setting module 110 and another permission.

### [In-Space Search Module]

When the migration destination of an app is in a space, an in-space search module 112 sets the app as a search target in the space. The in-space search refers to a search that uses the information in a space as a search target. In the in-space search, all or a part of the information in a space is set as an index. Not only apps but also other information including threads are exchanged in a space, and hence the other information is also set as the search target in the in-space search. When the migration destination of an app is a space, the in-space search module 112 creates an index for the in-space search so that the app is included in the search target in the in-space search in the space. When the app is migrated, the app is no longer hit in the in-space search at the migration source. When processing for reflection in the in-space search at the migration destination is completed, a message to that effect may be displayed.

For example, the in-space search module 112 executes an in-space search based on a query input from an input form labeled “IN-SPACE SEARCH” on the space screen SC2 of FIG. 4. The in-space search module 112 also sets, as an index for the in-space search, actual data of an app migrated to the space being displayed on the space screen SC2. In the at least one embodiment, there are also a global search performed on the portal screen SC1 of FIG. 2 and an in-app search performed on, for example, the app screen SC3 of FIG. 5. In a full-text search, all information in the user group is set as the search target. In the in-app search, the actual data in the app is set as the search target.

### [4. Processing to be Executed by App Migration System]

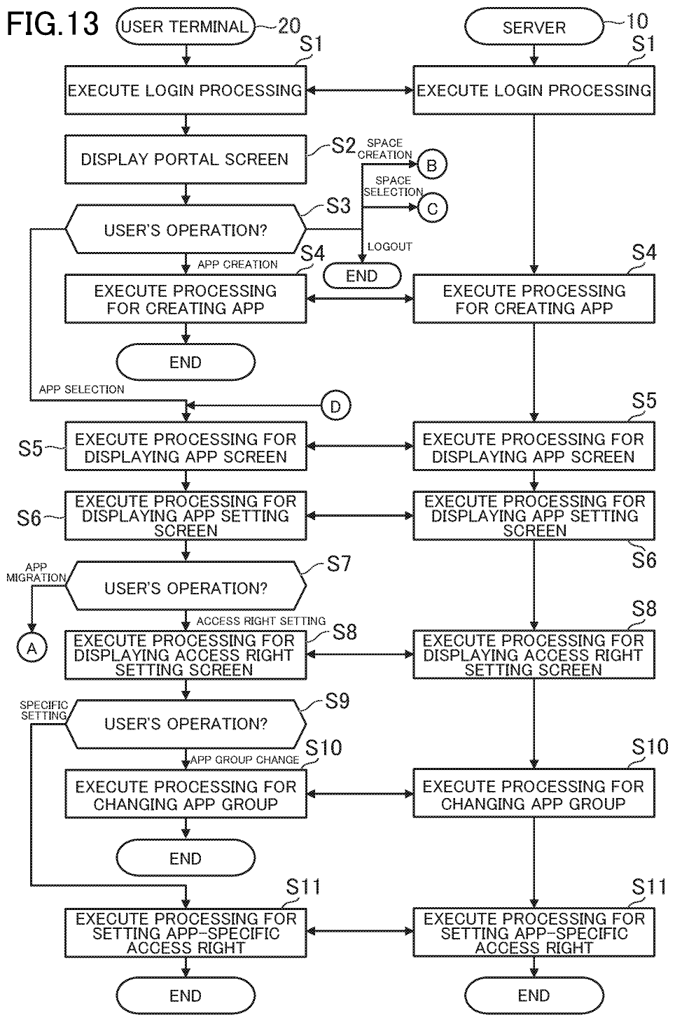

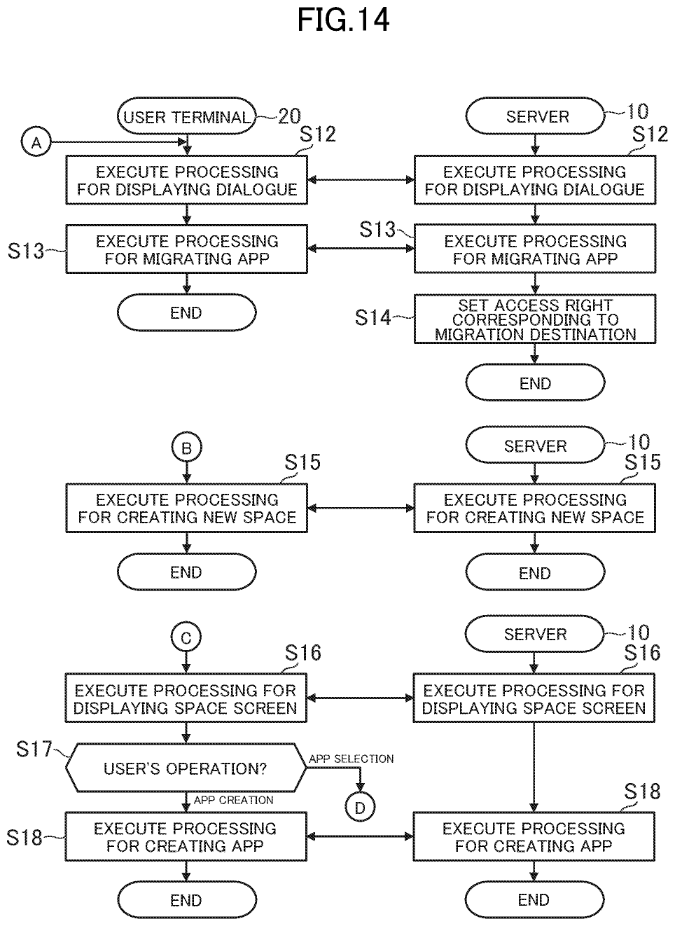

FIG. 13 and FIG. 14 are flow charts for illustrating an example of processing to be executed by the app migration system S. The processing of FIG. 13 and FIG. 14 is implemented by the controllers 11 and 21 executing the programs stored in the storages 12 and 22, respectively. It is assumed that the user has been invited to some user group before the processing of FIG. 13 and FIG. 14 is executed.

The user terminal 20 accesses a subdomain of a user group to which the user has been invited, and executes login processing in cooperation with the server 10 based on the user ID and password input by the user (Step S1). When the login processing is successful, the user terminal 20 displays the portal screen SC1 on the display 25 (Step S2). The user terminal 20 receives the user's operation performed on the portal screen SC1 (Step S3). Any operation can be performed on the portal screen SC1, but it is assumed here that an operation for creating an app, an operation for selecting an app in the display area A10, an operation for creating a space, or an operation for selecting a space in the display area A11 is performed. When the user performs a predetermined logout operation (“LOGOUT” in Step S3), this processing is ended.

When the user performs the operation for creating an app in Step S3 (“APP CREATION” in Step S3), the user terminal 20 executes processing for creating an app in cooperation with the server 10 (Step S4). This processing itself may be known processing, and the server 10 updates the app database DB2 so that the newly created app is placed outside the space. When the user performs the operation for selecting an app in the display area A10 in Step S3 (“APP SELECTION” in Step S3), the user terminal 20 executes processing for displaying the app screen SC3 in cooperation with the server 10 (Step S5). In Step S5, the server 10 refers to the app database DB2 to acquire information relating to the app selected by the user, and generates data for displaying the app screen SC3.

After that, processing for information sharing using the app is executed. In this case, processing for changing the settings of the app is described. When the icon 130 is selected, the user terminal 20 executes processing for displaying the app setting screen SC4 in cooperation with the server 10 (Step S6). The user terminal 20 receives the user's operation performed on the app setting screen SC4 (Step S7). Any operation can be performed on the app setting screen SC4, but it is assumed here that an operation for setting the access right to the app or an operation for migrating the app is performed.

When the operation for setting the access right to the app is performed (“ACCESS RIGHT SETTING” in Step S7), the user terminal 20 executes processing for displaying the access right setting screen SC5 in cooperation with the server 10 (Step S8). On the access right setting screen SC5, the current settings stored in the app database DB2 are displayed. The user terminal 20 receives the user's operation performed on the access right setting screen SC5 (Step S9). Any operation can be performed on the access right setting screen SC5, but it is assumed here that an operation for changing the app group or an operation for setting the app-specific access right is performed. In regard to the in-space app for which only “Public” can be set, the operation for changing the app group is not received.

When the user performs the operation for changing the app group (“APP GROUP CHANGE” in Step S9), the user terminal 20 executes processing for changing the app group in cooperation with the server 10 (Step S10). In Step S10, the server 10 updates the app database DB2 so that the app group designated by the user is set. When the user performs the operation for setting the app-specific access right in Step S9 (“SPECIFIC SETTING” in Step S9), the user terminal 20 executes processing for setting the app-specific access right in cooperation with the server 10 (Step S11). In Step S11, the server 10 updates the app database DB2 so that the specific access right specified by the user from the input form F50 is set for the user, organization, or the like designated by the user from the input form F50.

When the user performs the operation for migrating the app in Step S7 (“APP MIGRATION” in Step S7), the user terminal 20 executes processing for displaying the dialogue D40 in cooperation with the server 10 (Step S12). In Step S12, the server 10 refers to the app database DB2 to acquire information including the placement location of the app to be migrated, and generates data of the dialogue D40. The user terminal 20 executes processing for migrating the app in cooperation with the server 10 based on the user's operation performed on the dialogue D40 (Step S13). In Step S13, the server 10 updates the app database DB2 so that the app to be migrated is migrated to the migration destination designated by the user in the dialogue D40.

The server 10 sets the access right corresponding to the migration destination for the app migrated in Step S13 (Step S14). In Step S14, the server 10 updates the app database DB2 so that the app group corresponding to the migration destination is set. As described above, even under the same app group of “Public,” when the migration destination is a private space, the app is set so that only the members of the private space can access the app.

When the user performs the operation for creating a space in Step S3 (“SPACE CREATION” in Step S3), the user terminal 20 executes processing for creating a new space in cooperation with the server 10 (Step S15). As the space creating processing itself, known processing can be used. When the user performs the operation for selecting a space in the display area A11 in Step S3 (“SPACE SELECTION” in Step S3), the user terminal 20 executes processing for displaying the space screen SC2 in cooperation with the server 10 (Step S16). In Step S16, the server 10 refers to the user group database DB1 to acquire information relating to the space designated by the user, and generates data of the space screen SC2.

The user terminal 20 receives the user's operation performed on the space screen SC2 (Step S17). Any operation can be performed on the space screen SC2, but it is assumed here that an operation for creating an in-space app or an operation for selecting an in-space app is performed. When the user performs the operation for creating an in-space app (“APP CREATION” in Step S17), the user terminal 20 executes processing for creating an app in cooperation with the server 10 (Step S18). In Step S18, the newly created app is placed in the space. When the user performs the operation for selecting an in-space app in Step S17 (“APP SELECTION” in Step S17), the process advances to Step S5, and the app screen SC3 is displayed.

According to the app migration system S of the at least one embodiment, when an app is migrated between the public space and the private space or between inside and outside the space, a permission corresponding to the migration destination of the app is set for the app. Accordingly, the permission corresponding to the migration destination is automatically set for the app migrated therebetween, and hence the user's time and labor for manually setting the permission can be reduced. In addition, when the user manually sets the permission, there is a fear in that the information is disclosed to an unintended person due to a setting error. However, through the setting of the permission corresponding to the migration destination, the information can be prevented from being disclosed due to a setting error. As a result, the risk of leakage of confidential information and other information is reduced, and the security of the confidential information and other information is enhanced. The app is also enabled to be migrated between freely-selected spaces or to the outside of the space, to thereby eliminate time and labor for copying the app to create a new app, for example.

Further, in the app migration system S, even when the app is migrated, the settings of the permission specific to the app are maintained. This prevents the permission specific to the app from being rewritten without permission and the information from being disclosed to an unintended person. As a result, confidential information and other information can be prevented from being leaked, and important information can be prevented from being rewritten by someone.

Further, the app migration system S controls access to an app based on the logical product of the permission corresponding to the migration destination of the app and the permission specific to the app. Accordingly, it is not required to set complicated permissions for each app, and it suffices to be aware of those two permissions, to thereby be able to reduce the user's time and labor. In addition, the range for disclosing information is narrowed down through use of the logical product of permissions, to thereby be able to reduce the risk of information being disclosed to an unintended person with more effectiveness.

Further, the app migration system S controls access to the app based on the logical product of the permission common to a plurality of apps and another permission. This enables the permission common to a plurality of apps to be collectively set, and hence a burden imposed on the user who sets the permission for the app is reduced. In addition, the security of an app can be ensured by controlling the access to the app in consideration of other permissions as well.

Further, the app migration system S determines whether or not a user instructing the migration of an app has the app management permission and the user has the app creation permission at the migration destination of the app. This can prevent the app from being migrated by an unintended person and the information from being disclosed thereby. As a result, confidential information and other information can be prevented from being leaked, and important information can be prevented from being rewritten by someone.

Further, when the migration source of an app is in a space, the app migration system S determines whether or not the user instructing the migration of the app has the permission to manage the space. This can prevent the app from being migrated by an unintended person and the information from being disclosed thereby. In particular, an app placed in a private space is often highly confidential, and hence such information can be prevented from being leaked, and important information can be prevented from being rewritten by someone.

Further, the app migration system S restricts the migration of an app between the guest space and another space. This can prevent the app from being disclosed to an unintended person and from being taken out by an unintended person. In particular, the guest space is a space that can be accessed by a person who does not belong to the user group as well, and hence it is possible to reduce the risk of information being disclosed to such a space due to a setting error or another issue with more effectiveness.

Further, when the condition for migrating an app is not satisfied, the app migration system S notifies the user instructing the migration of the app of a reason therefor. This enables the user to easily grasp the reason that the app cannot be migrated, and enhances the convenience of the user.

Further, the app migration system S receives the designation of the migration destination performed by the user instructing the migration of the app from among the search results of the spaces to which the app can be migrated. This enables the user to easily grasp the space to which the app can be migrated, and enhances the convenience of the user.

Further, when the migration destination of an app is in a space, the app migration system S sets the app as a search target in the space. Accordingly, after an app is migrated, information of the app can be retrieved in the space of the migration destination, and hence the information sharing can be performed more quickly in the space of the migration destination.

### [5. Modification Example]

The present disclosure is not limited to the at least one embodiment described above, and can be modified suitably without departing from the spirit of the present disclosure.

For example, the app migration system S may be able to migrate an app between a plurality of spaces irrespective of the type of space. In this case, the migration module 108 migrates the app between the plurality of spaces. For example, the migration module 108 migrates an app from one public space to another public space. In this case as well, the first setting module 102 may set the access right corresponding to the public space of the migration destination for the app. The app migration system S according to a modification example of the present disclosure may include the placement module 101, the first setting module 102, the migration module 108, the second setting module 109, and the in-space search module 112. Details thereof are as described above in the at least one embodiment.

According to the app migration system S of the modification example, when the migration destination of an app is in a space, the app is set as a search target in the space. Accordingly, after an app is migrated, information of the app can be retrieved in the space of the migration destination, and hence the information sharing can be performed more quickly in the space of the migration destination.

For example, in the at least one embodiment, the cases in which the migration of the app is prohibited when the migration source of the app is the guest space and when the migration destination of the app is the guest space are described, but the migration of the app in those cases may be permitted. For example, the type of space is not limited to the example of the at least one embodiment, and any type of space may be provided. Any permission may be set as the permission corresponding to the placement location of the app. For example, each public space may have its own permission set therefor, or each private space may have its own permission set therefor. In addition, for example, each guest space may have its own permission set therefor.

For example, each of the functions described above may be implemented by a freely-selected computer in the app migration system S. For example, the function described as being implemented by the server 10 may be implemented by the user terminal 20. The function described as being implemented by the user terminal 20 may be implemented by the server 10. Each of the functions may be shared by a plurality of computers. The functions may be implemented by one computer.

What is claimed is:

1. An app migration system, comprising at least one processor configured to:
place an app in one of an inside and an outside of a space joined by at least one user in a user group in which information is shareable;
set, for the app, a permission corresponding to a placement location of the app;
migrate the app in one of a route between a public space and a private space and a route between the inside and the outside of the space; and
set, for the migrated app, a permission corresponding to a migration destination of the app.

2. The app migration system according to claim 1,
wherein the at least one processor is configured to set, for the app, a permission specific to the app, and
wherein the settings of the permission specific to the app are maintained even when the app is migrated.

3. The app migration system according to claim 2, wherein the at least one processor is configured to control access to the app based on a logical product of the permission corresponding to the migration destination of the migrated app and the permission specific to the app.

4. The app migration system according to claim 1,
wherein the app includes a plurality of apps, and
wherein the at least one processor is configured to:
set a permission common to the plurality of apps; and
control access to the app for which the permission has been set, based on a logical product of the set permission and another permission.

5. The app migration system according to claim 1, wherein the at least one processor is configured to:
determine whether a user instructing the migration of the app has an app management permission and the user has an app creation permission at the migration destination of the app; and
migrate the app based on a result of the determination.

6. The app migration system according to claim 5, wherein the at least one processor is configured to further determine whether the user instructing the migration of the app has a permission to manage the space, when a migration source of the app is in the inside of the space.

7. The app migration system according to claim 1, wherein the at least one processor is configured to restrict the migration of the app relating to the space which is set so that information to be shared therein is isolated.

8. The app migration system according to claim 1, wherein the at least one processor is configured to:
migrate the app when a predetermined condition is satisfied; and
notify a user instructing the migration of the app of a reason that the predetermined condition is not satisfied, when the predetermined condition is not satisfied.

9. The app migration system according to claim 1, wherein the at least one processor is configured to:
migrate the app when a predetermined condition is satisfied;
search for the space to which the app is allowed to be migrated based on the predetermined condition;
receive, from among results of the search, designation of the migration destination performed by the user instructing the migration of the app; and
migrate the app to the migration destination designated by the user.

10. The app migration system according to claim 1, wherein the at least one processor is configured to set the app as a search target in the space when the migration destination of the app is in the inside of the space.

11. An app migration system, comprising at least one processor configured to:
place an app in one of an inside of one of a plurality of spaces and an outside of the plurality of spaces, the plurality of spaces each being joined by at least one user in a user group in which information is shareable;
set, for the app, a permission corresponding to a placement location of the app;
migrate the app between the plurality of spaces;
set, for the migrated app, a permission corresponding to a migration destination of the app; and
set the app as a search target in the another one of the plurality of spaces, when the migration destination of the app is in the inside of another one of the plurality of spaces.

12. A non-transitory information storage medium having stored thereon a program for causing a computer to:
place an app in one of an inside and an outside of a space joined by at least one user in a user group in which information is shareable;
set, for the app, a permission corresponding to a placement location of the app;
migrate the app in one of a route between a public space and a private space and a route between the inside and the outside of the space; and
set, for the migrated app, a permission corresponding to a migration destination of the app.

13. A non-transitory information storage medium having stored thereon a program for causing a computer to:
place an app in one of an inside of one of a plurality of spaces and an outside of the plurality of spaces, the plurality of spaces each being joined by at least one user in a user group in which information is shareable;
set, for the app, a permission corresponding to a placement location of the app;
migrate the app between the plurality of spaces;
set, for the migrated app, a permission corresponding to a migration destination of the app; and
set the app as a search target in the another one of the plurality of spaces, when the migration destination of the app is in the inside of another one of the plurality of spaces.
